(19) United States
(12) Patent Application Publication
(10) Pub. No.: US 2011/0096035 A1
(43) Pub. Date: Apr. 28, 2011

(54) LIQUID CRYSTAL DISPLAY

(76) Inventor: Yuhren SHEN, (US)

(21) Appl. No.: 12/984,423

(22) Filed: Jan. 4, 2011

(30) Foreign Application Priority Data
Sep. 9, 2010 (TW) 099130568

(51) Int. Cl. G06F 3/042

(52) U.S. Cl. 345/175

(57) ABSTRACT

A liquid crystal display comprises a liquid crystal module, a backlight module, a driving and detecting module, and plural photo-sensors; the said liquid crystal module contains polarizers, glass plates, liquid crystal, color filters, thin film transistors (TFTs), black matrixes, and various lines; the said backlight module contains light source, light guide, and diffuser; the said driving and detecting module contains date driver, gate driver, photo-sensor driver, and photo-sensing detector; the said plural photo-sensors contains P-N diodes or thin film transistors; each of the said plural photo-sensors is respectively installed at each pixel unit; the plural photo-sensors are used to sense the red and infrared rays which are first emitted from the light source, then pass through the liquid crystal module, and are finally reflected from the touch finger of the user using the optical touch-sensitive liquid crystal display, and are used to provide the sensed signals for the determination of the touch location of the user finger.

### FIELD

The present invention relates to a liquid crystal display, especially relates to an optical touch-controlled liquid crystal display.

### BACKGROUND

Information, energy source, and biology sciences and technologies are the three very important ones at present. The two most important foundation stones for the information science and technology are the display and the semiconductor integrated circuit. The display is a window for the information transmission between the mankind and the machine. It has become a very important device which is indispensable to the moderns. The display can be used for various facilities such as portable phone, digital camera, video camera, notebook computer, desk computer, television receiver, projector, and so on. There are many kinds of displays, which are cathode ray tube (CRT) display, liquid crystal display (LCD), plasma display panel (PDP), light emitting diode (LED) display, field emitting display (FED), vacuum fluorescence display panel (VFD), electroluminescence display panel (ELP), and so on. The liquid crystal display is the most frequently used and is the leading one among these.

The liquid crystal display has been developing to one lighter in weight, thinner in thickness, and higher in performance. For the convenience of users to carry and operate there then has a touch-controlled liquid crystal display developed and manufactured. The key technology for the touch-controlled liquid crystal display is how to detect out the touch location of the user on the display panel. For the present, the detecting methods for the touch location have optical, ultrasonic, resistance of, and capacitance of touch controls. These traditional methods have the necessity of adding other elements so that the volume, the weight, and the making cost of the display are all increased, and even some performances of the display, such as the open ratio which affects the brightness, are reduced.

For the traditional panel of touch-controlled liquid crystal display, there are numerous infrared sources and corresponding photo-sensors are installed at the top periphery of the panel to detect and determine the touch location of the user on the panel.

The design like this not only increases the volume and the weight of the panel but also increases the complexity of the making process and the making cost. In the optical touch-controlled liquid crystal display disclosed in the present invention, the photo-sensors are integratedly formed in the liquid module by a method like one of making semiconductor integrated circuit, and the infrared rays from the backlight are used for sensing, therefore, the volume and the weight of the panel cannot be increased, and the complexity and the cost in the making process also cannot be increased. Additionally, the performance of the optical touch-controlled panel can be prompted.

### SUMMARY

The object of the present invention is to provide a liquid crystal display, the chief aspect of which is that each of the pixel units in the display has one photo-sensor used for sensing the infrared rays which are first emitted from the light source, then pass through the liquid crystal module, and are finally reflected from the touch finger of the user using the optical touch-sensitive liquid crystal display, and used to provide the sensed signals for the determination of the touch location of the user finger.

A liquid crystal display according to the present invention comprises a liquid crystal module, a backlight module, a driving and detecting module, and plural photo-sensors, wherein the liquid crystal module contains an upper glass plate, a lower glass plate, plural pixel units, and plural thin film transistors; the backlight module contains a visible light source, and an infrared source; each of the plural photo-sensors is installed on the glass plate in each of the pixel units. The photo-sensors are used for sensing the infrared rays which are first emitted from the light source, then pass through the liquid crystal module, and are finally reflected from the touch finger of the user using the optical touch-sensitive liquid crystal display, and are used to provide the sensed signals for the determination of the touch location of the user finger.

### BRIEF DESCRIPTION OF THE DRAWINGS

The present invention can be more completely understood by considering the detailed description of various embodiments of the present invention in connection with the accompanying drawings, in which:

FIG. 1A is a schematic cross-section view of the liquid crystal display according to one example embodiment of the present invention;

FIG. 1B is an equivalent circuit diagram for the structure shown in FIG. 1A;

FIG. 1C is a schematic view of the partial elements in the structure shown in FIG. 1A;

FIG. 2A is a schematic cross-section view of the liquid crystal display according to another example embodiment of the present invention;

FIG. 2B is an equivalent circuit diagram for the structure shown in FIG. 2A;

FIG. 2C is a schematic view of the partial elements in the structure shown in FIG. 2A;

FIG. 3 is a schematic cross-section view of the liquid crystal display according to another example embodiment of the present invention;

FIG. 4A is a diagram showing the relation of absorption ratio vs. radiation wavelength (300˜1100 nm) for the polycrystalline silicon and the amorphous silicon;

FIG. 4B is a diagram showing the relation of reflection ratio vs. radiation wavelength (300˜1100 nm) from the mankind skin;

FIG. 4C is a diagram showing the relation of transmission ratio vs. radiation wavelength (300˜1100 nm) passed three cross polarizers, respectively;

FIG. 5A is a diagram showing the relation of total efficiency vs. radiation wavelength (300˜1100 nm) passed through the amorphous silicon and various cross polarizers, and then reflected from the mankind skin, respectively;

FIG. 5B is a diagram showing the relation of total efficiency vs. radiation wavelength (300˜1100 nm) passed through the polycrystalline silicon and various cross polarizers, and then reflected from the mankind skin, respectively;

FIG. 6 is a diagram showing the relation of transmitted intensity vs. radiation wavelength (300˜1100 nm) passed through the backlight thin film transistor liquid crystal display at turned on and turned off state, respectively.

### DETAILED DESCRIPTION

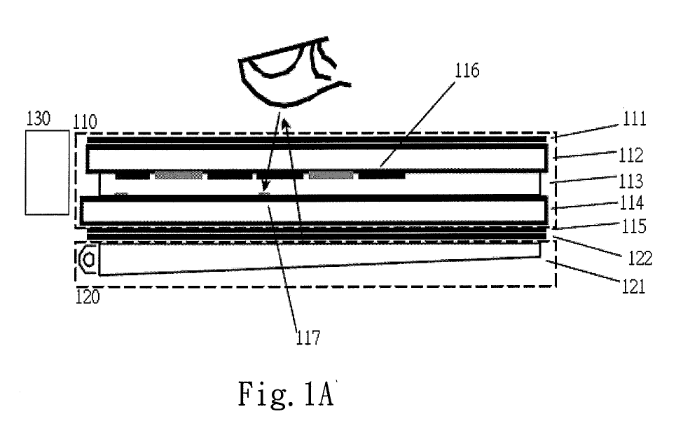

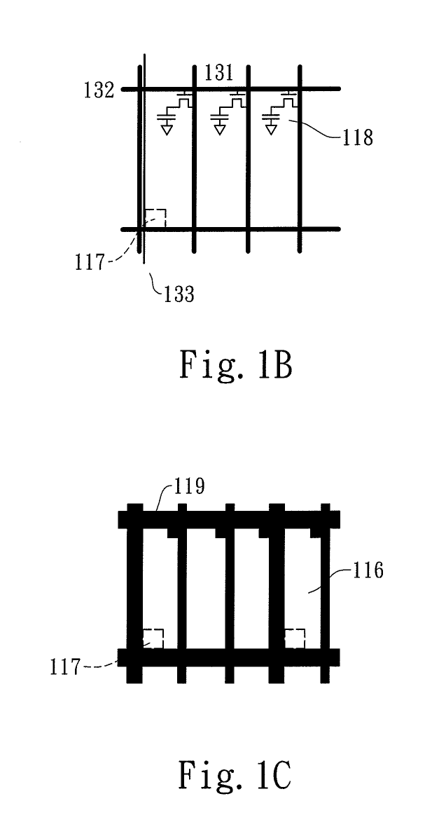

FIG. 1A is a schematic cross-section view of the liquid crystal display according to one example embodiment of the present invention, which comprises a liquid crystal module 110, a backlight module 120, and a driving and detecting module 130. The liquid crystal module 110 contains an upper polarizer 111, an upper glass plate 112, a liquid crystal 113, a lower glass plate 114, a lower polarizer 115, a color filter 116, a photo-sensor 117, a black matrix 119 (unshown in FIG. 1A), a thin film transistor 118 (unshown in FIG. 1A), and various lines 131, 132, and 133 (unshown in FIG. 1A). The photo-sensor 117 is installed on the inner surface of the lower glass plate 114. The backlight module 120 contains a light source (unshown), a light guide plate 121, and a diffuser 122. The driving and detecting module 130 contains a data driver (unshown), a gate driver (unshown), a photo-sensor driver (unshown), and a photo-sensing detector (unshown).

FIG. 1B is an equivalent circuit diagram for the structure shown in FIG. 1A, which contains three thin film transistors 118, a photo-sensor 117, a date line 131, a gate line 132, and a sensing line 133. The photo-sensor 117 is installed at the lower-left corner of the pixel unit (to look downward).

FIG. 1C is a schematic view of the partial elements in the structure shown in FIG. 1A, which shows the relative locations of the photo-sensor 117, the color filter 116, and the black matrix 119.

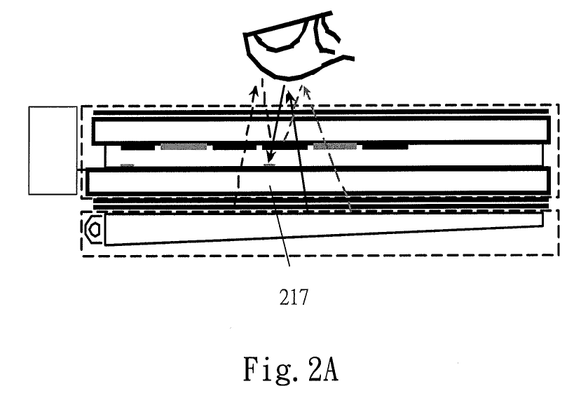

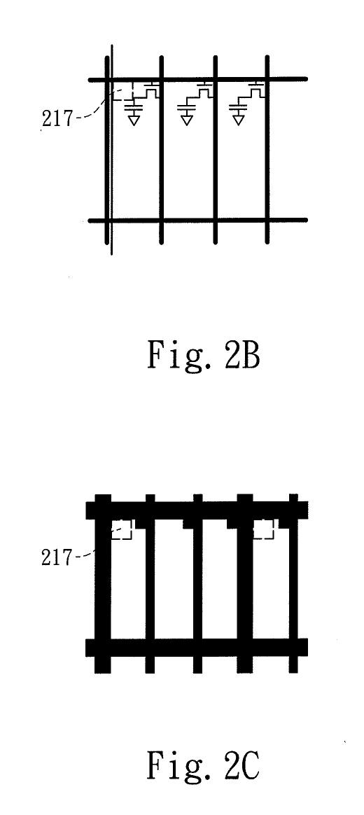

FIG. 2A, 2B, and 2C are schematic views for the cross-section structure, equivalent circuit, and partial elements of the liquid crystal display according to another example embodiment of the present invention, which are the same as the schematic views shown in FIG. 1A, 1B, and 1C, with the exception of the location of the photo-sensor 217. In this example embodiment of the present invention the photo-sensor 217 is installed at the upper-left corner of the pixel unit (to look downward) as shown in FIG. 2B, and 2C.

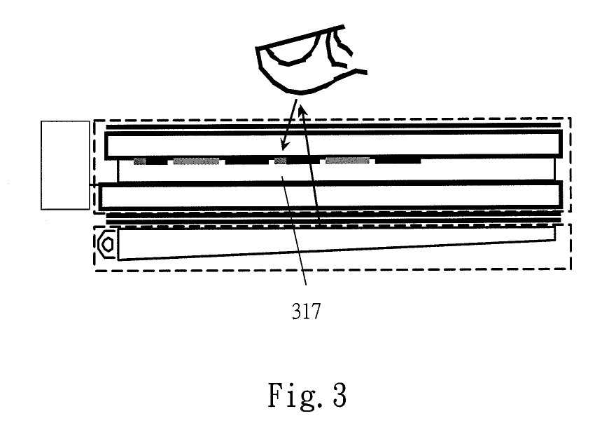

FIG. 3 is a schematic cross-section view of the liquid crystal display according to another example embodiment of the present invention, which is the same as the schematic views shown in FIG. 1A and 2A, with the exception of the location of the photo-sensor 317. In this example embodiment of the present invention the photo-sensor 317 is installed on the inner surface of the upper glass plate 312 and at either lower left or upper-left corner (to look downward) of the pixel unit.

The key technology of the present invention lies in the use of the infrared rays which are first emitted from the backlight module, then pass through the liquid crystal module and are reflected from the touch finger of the user using the optical touch-sensitive liquid crystal display, and are finally detected by the photo-sensors in the pixel units, wherein the photo-sensors are generally made of polycrystalline silicon or amorphous silicon. Therefore it is necessary to know the radiation absorptivity of the polycrystalline silicon and the amorphous silicon, the radiation reflectivity of the mankind skin, and the radiation transmissivity of the polarizers.

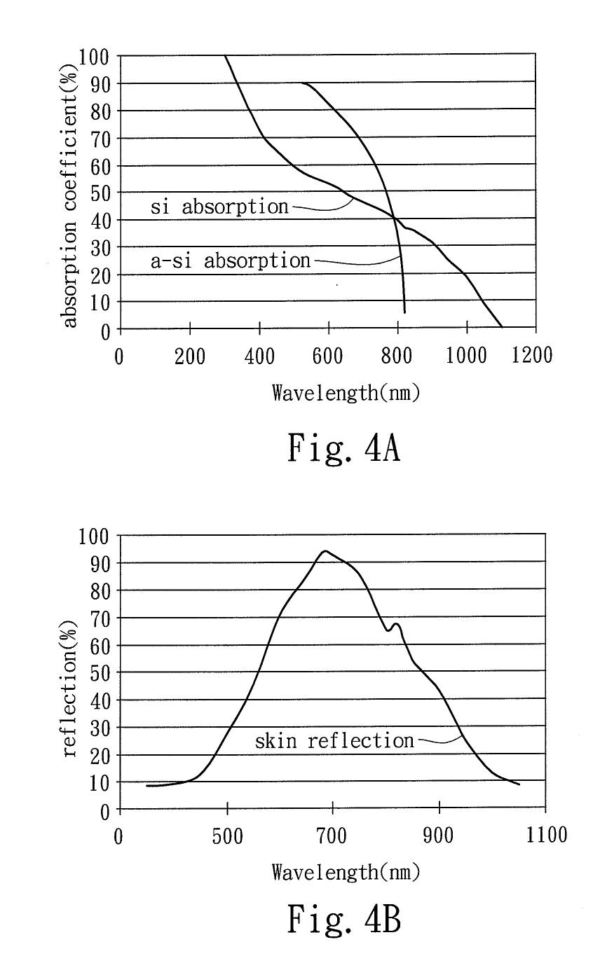

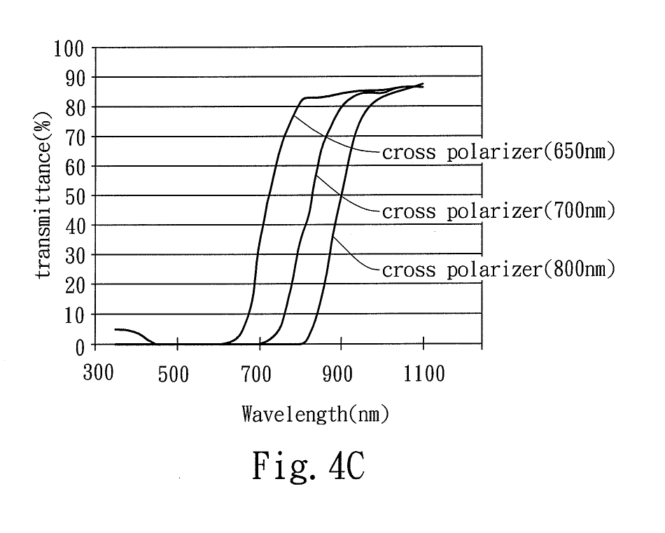

FIG. 4A is a diagram showing the relations of absorption ratio vs. radiation wavelength (300˜1100 nm) for the polycrystalline silicon and the amorphous silicon. It can be seen from the curves that the longer the wavelength, the less the absorption for both polycrystalline silicon and amorphous silicon. For the radiation about 800 nm, the absorption ratio is about 40% for both polycrystalline silicon and amorphous silicon. For the absorption of the radiation shorter than 800 nm, the amorphous silicon is better than the polycrystalline silicon. The absorption ratio decreases quickly down to zero for the amorphous silicon when the wavelength of the radiation is larger than 800 nm. In other words, the radiation of 800˜1100 nm wavelength can passes almost completely through the amorphous silicon, and the absorption ratio of the radiation of 800˜1100 nm wavelength is smaller than 40% for the polycrystalline silicon.

FIG. 4B is a diagram showing the relation of reflection ratio vs. radiation wavelength (300˜1100 nm) from the mankind skin. It can be seen from the curve that the mankind skin has the largest reflection ratio (over 90%) for the radiation about 700 nm, and has reflection ratio about 65% for the radiation about 800 nm, about 40% for the radiation about 900 nm, and about 15% for the radiation about 1000 nm.

FIG. 4C is a diagram showing the relation of transmission ratio vs. radiation wavelength (300˜1100 nm) passed through three cross polarizers, respectively. It can be seen from the curves that cross polarizer of 650 nm, 700 nm, and 800 nm can stop the radiation shorter than 650 nm, 700 nm, and 800 nm, respectively, and all of them have transmission ratio about 85% for the radiation longer than 650 nm, 700 nm, and 800 nm, respectively. In other words, the cross polarizers can effectively stop the radiation of short wavelength, but they can stop only about 15% radiation of long wavelength.

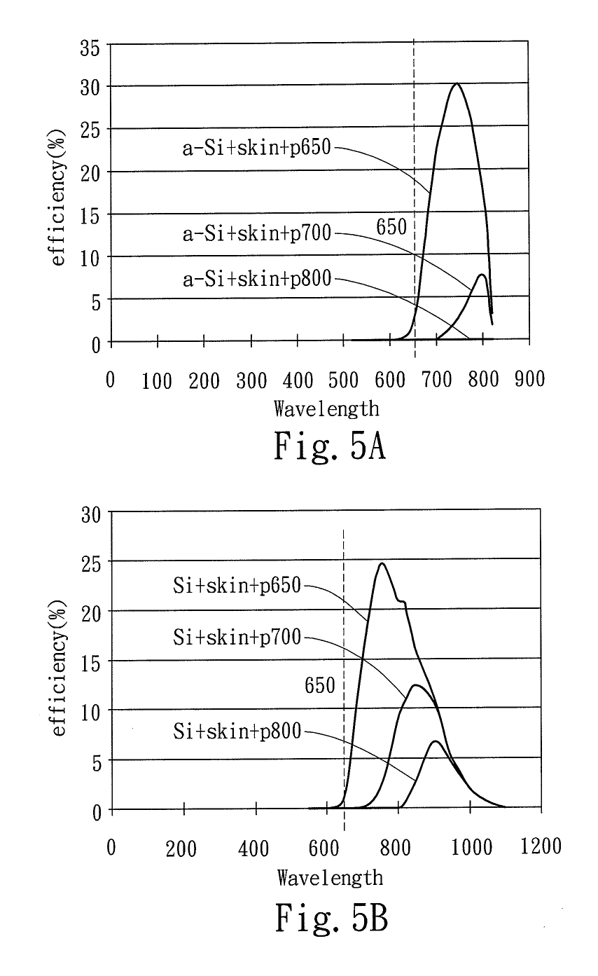

For understanding the usable range of the infrared rays disclosed in the present invention, it is helpful to together consider the absorption spectrum of the polycrystalline silicon and the amorphous silicon, the reflection spectrum of the mankind skin, and the transmission spectrum of the polarizers. FIG. 5A is a diagram showing the relation of total efficiency vs. radiation wavelength (300˜1100 nm) passed through the amorphous silicon and various cross polarizers, and then reflected from the mankind skin, respectively. It can be seen from the curves that for the polarizer of 650 nm, the responding radiation range is between 650 nm and 820 nm and the maximum efficiency (about 30%) occurs at 750 nm radiation; for the polarizer of 700 nm, the responding radiation range is between 700 nm and 820 nm and the maximum efficiency (about 8%) occurs at 800 nm radiation; for the polarizer of 800 nm, the responding efficiency is zero for all radiations of 300˜1100 nm.

FIG. 5B is a diagram showing the relation of total efficiency vs. radiation wavelength (300˜1100 nm) passed through the polycrystalline silicon and various polarizers, and then reflected from the mankind skin, respectively. It can be seen from the curves that for the polarizer of 650 nm, the responding radiation range is between 650 nm and 1100 nm and the maximum efficiency (about 25%) occurs at 750 nm radiation; for the polarizer of 700 nm, the responding radiation range is between 700 nm and 1100 nm and the maximum efficiency (about 12%) occurs at 850 nm radiation; for the polarizer of 800 nm, the responding radiation range is between 800 and 1100 nm and the maximum efficiency (about 7%) occurs at 900 nm radiation.

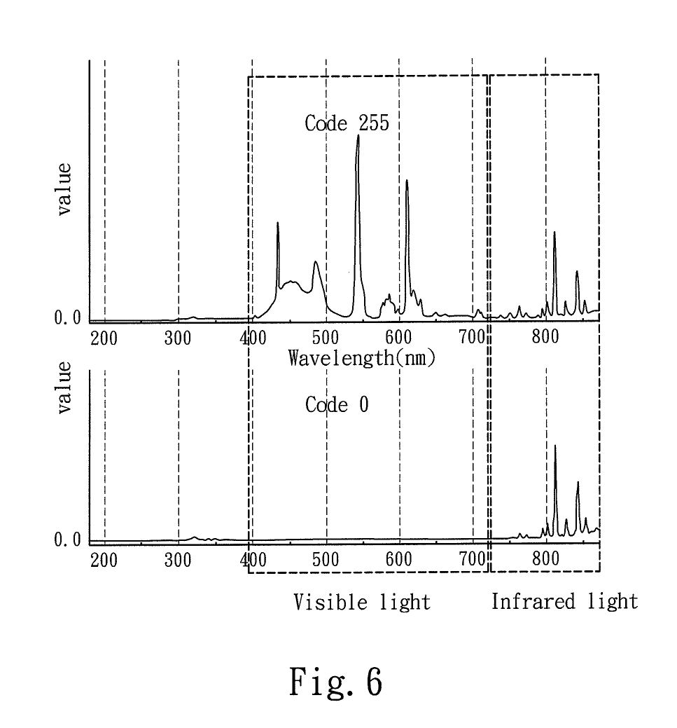

FIG. 6 is a diagram showing the relation of transmitted intensity vs. radiation wavelength (300˜1100 nm) passed through the backlight thin film transistor liquid crystal display at turned on and turned off states, respectively. The light source of the liquid crystal display is cold cathode fluorescent lamp (CCFL). The lower curve in FIG. 6 shows the transmitted intensity of various wavelength radiations for the liquid crystal display at turned off state. It can be seen from this curve that the visible radiation about 400˜700 nm is completely stopped by the polarizer, but the infrared radiation about 800˜900 nm can still pass through. The upper curve in FIG. 6 shows the transmitted intensity of various wavelength radiations for the liquid crystal display at turned on state. It can be seen from this curve that both visible light (blue, green, and red, BRG) and infrared rays (about 800˜900 nm) can pass through. Comparison between these two curves of transmitted intensity in FIG. 6 shows that no matter whether the liquid crystal display is on or off, the infrared part (about 800˜900 nm) in backlight can pass through it. This phenomenon is used to make the optical touch-sensitive liquid crystal display in the present invention.

Turning to FIG. 1A, 2A, and 3 again, when the finger of the user touches the panel surface of the liquid crystal display of the present invention, the photo-sensors under the finger would receive the radiation (650˜1100 nm) reflected from the finger and would respond accordingly. In the meanwhile, the other photo-sensors in the display would not receive the radiation reflected from the finger, so they would not respond accordingly. The response of the photo-sensors under the touch finger can be detected by using a read out circuit, and can be used to determine the touch location of the finger for the control of the liquid crystal display.

The light source of the backlight module in the optical touch-sensitive liquid crystal display of the present invention can be a cold cathode fluorescent lamp (CCFL) of which radiation contains visible light and infrared rays. The visible light can be used for the display and the infrared rays can be used for the control of the liquid crystal display.

The light source of the backlight module in the optical touch-sensitive liquid crystal display of the present invention can also be white light emitting diode (WLED) and infrared light emitting diode (IRLED). The radiation of white light emitting diode (WLED) can be used for the display and the radiation of infrared light emitting diode (IRLED) can be used for the control of the liquid crystal display.

The photo-sensors in the optical touch-sensitive liquid crystal display of the present invention can be made of P-N diodes or thin film transistors (TFT). When the photo-sensors are made of P-N diodes, the P-N diodes would be applied a reverse bias in the operation process. When the P-N diodes with a reverse bias receive the infrared rays reflected from the user finger, a reverse current in the P-N diodes would be produced. The reverse current can be read out and used for the determination of the touch location of the user finger. When the photo-sensors are made of thin film transistors (TFTs), the thin film transistors (TFTs) are used as a diode under a forward bias in the operation process.

To sum up, the liquid crystal display disclosed in the present invention comprises a liquid crystal module, a backlight module, and a driving and detecting module. The chief characteristic of the present invention is that there are plural photo-sensors installed on the inner surface of the lower glass plate or the upper glass plate of the liquid crystal cell, and the long wavelength radiation (650˜1100 nm) of the backlight, which can highly transmit the liquid crystal cell and be reflected from the user finger, can be used to determine the touch location of the user finger. Because the photo-sensors are installed inside the liquid crystal cell and the additional infrared source besides the backlight can be omitted, the volume and the weight, together with the making cost can be reduced for the liquid crystal display disclosed in the present invention.

Although the liquid crystal display disclosed in the present invention has been in detail described with reference to several example embodiments, the present invention cannot be limited by these example embodiments. Those skilled in the field related with the present invention can make various changes to these example embodiments without departing from the spirit and scope of the present invention. Therefore, the aspects of the present invention are set forth in the following claims.

1. A liquid crystal display, comprising:
a liquid crystal module which contains an upper glass plate, a lower glass plate, plural pixel units, and plural thin film transistors;
a backlight module which contains a visible light source and an infrared source;
a driving and detecting module; and
plural photo-sensors, each of which is installed on the glass plate in every pixel cell, which are used for sensing the infrared rays which are first emitted from the light source, then pass through the liquid crystal module, and are finally reflected from the touch finger of the user using the optical touch-sensitive liquid crystal display, and are used to provide the sensed signals for the determination of the touch location of the user finger.

2. A liquid crystal display according to claim 1, wherein the plural photo-sensors are installed on the inner surface of the lower glass plate in the liquid crystal module.

3. A liquid crystal display according to claim 2, wherein each of the thin film transistors is installed at one corner of every pixel unit, and each of the photo-sensors is in stalled at any other corner of the pixel unit.

4. A liquid crystal display according to claim 1, wherein the plural photo-sensors are installed on the upper surface of the lower glass plate in the liquid crystal module.

5. A liquid crystal display according to claim 4, wherein each of the thin film transistors is installed at one corner of every pixel unit, and each of the photo-sensors is in stalled at any other corner of the pixel unit.

6. A liquid crystal display according to claim 1, where in both the visible light source and the infrared source in the backlight module are cold cathode fluorescent lamp.

7. A liquid crystal display according to claim 1, wherein the visible light source is white light emitting diode, and the infrared source is infrared light emitting diode in the backlight module.

8. A liquid crystal display according to claim 1, wherein the wavelength of the infrared emitted from the infrared source ranges from 650 nm to 1100 nm.

9. A liquid crystal display according to claim 1, wherein the photo sensors are made up of diodes which can detect the radiation of 650˜1100 nm wavelength.

10. A liquid crystal display according to claim 1, wherein the photo-sensors are made up of thin film transistors.

11. A liquid crystal display according to claim 10, wherein the thin film transistors of the photo-sensors operate under a forward bias voltage applied between the source and the drain of the thin film transistor.
